(19) United States
(12) Patent Application Publication
(10) Pub. No.: US 2002/0027213 A1
(43) Pub. Date: Mar. 7, 2002

(54) Extended range proportional valve method

(76) Inventor: Davis K. Jensen, Lomita, CA (US)

Correspondence Address: Ephraim Starr, Honeywell Power Systems Inc., 8725 Pan American Fwy. NE, Albuquerque, NM, 87113, US

(21) Appl. No.: 09/904,594

(22) Filed: Jul. 12, 2001

Related U.S. Application Data
(60) Provisional application No. 60/218,072, filed on Jul. 12, 2000.

(51) Int. Cl. F16K 31/02

(52) U.S. Cl. 251/129.05; 251/129.08

(57) ABSTRACT

A method for operating a proportional flow valve with a pilot valve member over an extended range and at a low flow rate. The pilot valve member may be operated, by varying the frequency or duty cycle or both of the pulse width modulated current applied to the solenoid, without thereby causing the main valve member to open.

### CROSS-REFERENCE TO RELATED APPLICATIONS

This application claims the benefit of the filing of U.S. Provisional Patent Application Serial No. 06/218,072, entitled Extended Range Proportional Valve, filed on Jul. 12, 2000, and the specification thereof is incorporated herein by reference.

### BACKGROUND OF THE INVENTION

1. Field of the Invention (Technical Field)

The present invention relates to methods for extending the range over which proportional flow valves may be operated, including operation of proportional flow valves over very low flow rates.

2. Background Art

A variety of proportional flow valves are known in the art. These valves are utilized in a variety of applications, including as mixing valves to blend different gasolines or other fuels, to mix hot and cold water to determined temperatures, and the like. These valves may also be employed where it is desirable to control flow, particularly over a large range. In one such application, proportional flow valves may be employed to control the flow of fuel into turbine engines, such as are employed on microturbine power generator systems. In this application, it is necessary to control the fuel flow over a continuous range from very low fuel flows to comparative high fuel flows.

One type of proportional flow valve known in the art is a valve commonly called a “dog-servo valve”, which includes a valve assembly with a solenoid actuated pilot valve which controls flow through a pilot opening in the main valve member, thereby controlling the main valve. Commercially available proportional flow valves of this type typically include the following arrangement of elements:

(a) a valve body including an inlet port, an outlet port, and a main valve seat mounted in the valve body,

(b) a main valve member movable into and out of engagement with the main valve seat,

(c) a pilot valve member movably mounted within the valve body into and out of engagement with a pilot valve seat to close and open the pilot valve member, and

(d) a solenoid actuator that includes a movable armature on which the pilot valve member is mounted, the solenoid actuator also having a coil through which an electrical current can be made to flow, with the armature of the solenoid actuator being movable in response to the frequency and/or amplitude of the current.

In such an arrangement of elements, the main valve member is movably mounted within the valve body into and out of engagement with the main valve seat to close and open the main valve member as a function of the movement of the pilot valve member.

In certain valves of this type, it is known to have the opening of the main valve member proportional to the amount of current applied to the solenoid actuator that positions the pilot valve member, such that that the amount of current applied to the solenoid actuator determines the amount of opening of the main valve member. Thus, if the current flowing through the solenoid is 50% of the maximum current, the armature rises through one-half of its maximum travel between the pilot valve member being fully opened and the pilot valve member being fully closed. As a result, the main valve member will rise through the same proportion, 50%, of its maximum travel, and hence the main valve will be opened at about one-half maximum flow. However, it is not possible to consistently or reproducibly operate such a valve in this manner at very low flow rates, i.e., on the order of less than about 5% maximum flow, and preferably on the order of about 1% to 2% maximum flow. It is known that at significant pressure differentials, the main valve member tends to move erratically, and to “jump” or suddenly open or close, thereby providing an uneven and unpredictable flow rate. Thus precise low flow rates cannot be attained using this method.

With certain valves of this type, it is also known to apply a pulsed signal, generally a pulsed DC signal, to the solenoid. It is also known to have the frequency of the DC pulses matched to the size of the valve, such that the pulse width modulation frequency is altered in inverse relation to an orifice controlling maximum flow through the valve. Thus the larger the orifice the lower the frequency of the DC pulses.

With other certain valves of this type, it is known to apply AC current to the solenoid. Half-wave rectified AC current may be applied to the solenoid, thereby causing oscillation of the pilot valve member in and out of engagement with the pilot valve seat. In this method, the half-wave rectified AC current is not sufficient to hold the pilot valve continuously open, and thus with such oscillation the pressure may decrease such that the main valve closes, while liquid flow continues through the pilot valve. However, this method can only be applied to decrease flow to a low rate from a high rate, such as with a self-service gasoline pump wherein a specific dollar amount of fuel is to be dispensed.

Some valves of this type employ a flexible diaphragm or similar pressure member operably connected to the valve body and to the main valve member, such that the pressure difference above and below the diaphragm causes the main valve member to engage or disengage from the main valve seat. In one embodiment, a bleed passageway is provided between the area above and below the diaphragm, thereby permitting fluid entering the valve to flow to both such areas. Thus, for example, when the area above the diaphragm is subject to inlet fluid pressure, this will urge the main valve member toward the main valve seat, thereby causing the main valve to remain closed. However, when the area above the diaphragm is open to the outlet port, such as by the solenoid actuator causing the pilot valve member to open, then the fluid in the area above the diaphragm escapes faster than fluid enters through the bleed passageway, with the resulting pressure decrease causing the main valve member to open.

All prior art proportional flow valves of this type are limited in that there is no method or means for operating the valves at very low flow rates, nor is there any method or means for incrementally altering the flow rate at very low flow rates. Proportional flow valves can be operated at any flow rate from a minimum flow rate wherein the pilot valve causes the main valve member to open to the maximum flow rate with the main valve member fully open. In a typical proportional flow valve, the “turndown ratio”, or ratio of the maximum flow to the minimum flow, is about 14:1. For many applications, however, a substantially greater turn-down ratio is required, up to on the order of about 100:1 or more. In these applications, the maximum flow rate is not changed, but the minimum flow is substantially and significantly lower, and is ideally adjustable over the very low flow rate.

A primary object of the present invention is to provide a method for operating a proportional flow valve at a very low flow rate.

Another object of the present invention is to provide a method for operating a proportional flow valve at a turn-down ratio of about 100:1 or more.

Another object of the present invention is to provide a method for incrementally altering the flow rate of a proportional flow valve at very low flow rates.

Yet another object of the present invention is to provide a method for operating a proportional flow valve at a very low flow rate during turbine, including microturbine, operations.

A primary advantage of the present invention is that it provides a method for operating conventional proportional flow valves at very low flow rates.

Another advantage of the present invention is that it provides a method for operating conventional proportional flow valves at a very low flow rate during turbine, including microturbine, operations.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a diagram of a prior art proportional control valve disclosed in U.S. Pat. No. 5,538,026; and

FIG. 2 is a diagram of a prior art proportional control valve with a diaphragm disclosed in U.S. Pat. No. 5,716,038.

### DESCRIPTION OF THE PREFERRED EMBODIMENTS

The invention provides a method for operating a proportional flow valve at low flow rates and over a continuous range. In one embodiment, the valve is operated such the main valve member does not lift off the main valve seat. The valve is operated by providing either pulse width or frequency modulation, or both, of the current applied to the solenoid which operates the pilot valve. By providing a pulse width modulated voltage signal to the solenoid, and varying the duty cycle of the signal, the combination of duty cycle and frequency of the current causes the pilot valve member to open and close at a desired time-opened to time-closed ratio. The time-opened to time-closed ratio may be maintained below the value at which the main valve member opens, such that the fuel flow is only through the pilot valve member, and no fuel flows through the main valve member. In operation, such control of the current in the solenoid coil causes the pilot valve member to bounce up and down on the pilot valve seat, or oscillate, at a rate that allows a specific and controllable amount of fuel to flow through the pilot opening. Further, such fuel flow rate may be continuously controlled at rates between no fuel flow, when the pilot valve member does not disengage from the pilot valve seat, through the fuel flow rate which causes the main valve member to open. Such control may be effected by modifying either the pulse width or frequency modulation, or both, of the current applied to the solenoid which operates the pilot valve.

In one embodiment, a proportional flow valve including a diaphragm pressure member is employed in the fuel valve subsystem of a natural gas operated microturbine system. The fuel valve subsystem includes a fuel valve manifold and four associated fuel valves, two of which are shut-off valves, and two of which are proportional flow control valves. Operated under the operating frequency conditions specified by the manufacturer, such proportional flow valves have a minimum level of controllable fuel flow of about 7 pounds per hour (pph) of natural gas. That is, on actuating the proportional flow valve, such valve would immediately open from no flow, or 0 pph, to about 7 pph. Similarly, on decreasing the fuel flow, the same valve would immediately close at a flow rate of about 7 pph. Thus fuel flow at a rate of between about 0 pph and about 7 pph could not be obtained either on initiating flow or decreasing flow. This results in undesired explosive turbine engine starts and stops, with associated undesirable noxious emissions.

Such proportional flow valve including a diaphragm pressure member, operated at the manufacturer's specified frequencies and current, had a maximum flow rate, with the main valve fully open, of about 100 pph of natural gas. This thus provided a turn-down ratio of about 100 pph to about 7 pph, or about 14:1. By applying an appropriate pulse width or frequency modulation to the solenoid actuating the pilot valve member, it is possible to bounce or oscillate the pilot valve member on the pilot valve seat at a rate such that the main valve does not open. Thus the pressure above the diaphragm is such that the main valve member is held against the main valve seat, and does not open. Further, by modifying either the frequency or the pulse width, or both, the rate of opening or oscillation of the pilot valve member on the pilot valve seat is varied, thereby causing the flow rate through the pilot valve to vary. By this means the rate of opening or oscillation of pilot valve member can be controlled such that the flow rate through the pilot valve is from zero to that flow required to cause the main valve member to open. Further, this method does not affect the maximum flow rate that can be achieved with the main valve fully open. Utilizing a proportional flow valve including a diaphragm pressure member, operated using natural gas, a flow from less than 1 pph to about 7 pph was achieved, all at such flow rates as did not cause the main valve to open. Thus a turn-down ratio of about 100 pph to less than 1 pph, or more than about 100:1, can be achieved.

In one embodiment, the method is used with a valve that includes a flexible diaphragm connected to the valve body and to a movable main valve unit. The diaphragm can be an inexpensive annular diaphragm mounted between the main valve member and the valve housing as a pressure member to counterbalance the force of the inlet fluid pressure on the main valve member. The valve includes a bleed passageway connecting the regions above and below the diaphragm, thereby permitting fluid entering the inlet port to occupy both regions. When the region above the diaphragm is pressurized by fluid from the inlet port of the valve it opposes the force of the inlet fluid pressure in the region below the diaphragm. The area of the main valve unit exposed to the region above the diaphragm has a larger effective area than the area of the main valve unit exposed to the region below the diaphragm, so that when the main valve unit is subjected to inlet fluid pressure, the main valve unit is urged toward the main valve seat to keep the valve closed. When the region above the main valve unit is open to the outlet port, the fluid in that region is permitted to escape faster than the bleed passageway can supply fluid, and the resulting pressure decrease in the region above the main valve unit causes a net force urging the main valve unit to move away from the main valve seat to open the valve, and keep it open. The valve includes a pilot valve with a pilot valve sealing member carried by the solenoid armature and a pilot valve seat fixed to and moveable with the main valve unit. The pilot valve controls the pressure of inlet fluid in the region above the main valve unit and the flow of inlet fluid to the outlet port. As a result, the position of the armature indirectly controls the position of the main valve unit. The bleed passageway continuously bleeds pressurized fluid from the inlet port to the reservoir above the main valve unit so as to keep the main valve unit sensitive to the control of inlet fluid pressure by the pilot valve. Utilizing such a valve with the method of this invention, a pulse width modulated voltage signal may be applied to the solenoid, which signal has a selectable maximum voltage and a selectably variable duty cycle. The signal induces a current in the solenoid, which current has an average value over time. By varying the duty cycle, and thereby varying the average value of the current, the pilot valve member is caused to open and close at a desired time-opened to time-closed ratio. The time-opened to time-closed ratio can be maintained below a value at which the main valve member opens, thereby permitting very low flow, below the minimum rate with the main valve member opened. Further, by varying the time-opened to time-closed ratio, the flow can be continuously adjusted from no flow to that flow rate which causes a pressure decrease in the region above the main valve unit, thereby causing a net force urging the main valve unit to move away from the main valve seat and to thereby open the main valve member.

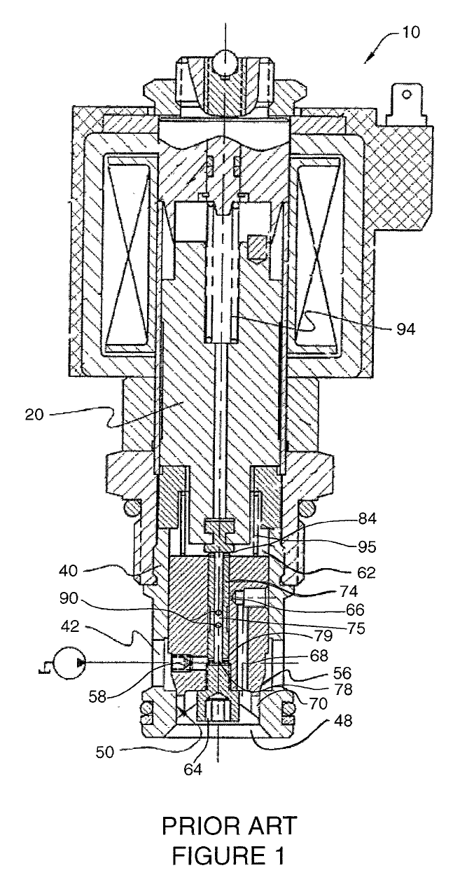

One pilot-operated proportional control valve with which this method may be used is disclosed in U.S. Pat. No. 5,538,026, entitle Pilot-Operated Proportional Control Valve, to S. A. Kazi (the '026 patent). In FIG. 1, the pilot-operated proportional control valve of the '026 patent is shown at 10, and is as described in the '026 patent. During operation, the housing inlet 42 is connected to a fluid supply and the housing outlet 48 is connected to a fluid-operated device. Fluid through the inlet 42 travels through a first flow path from radial entrance 58, through radial inlet orifices 79 at the lower end of pilot valve member 74, axially upward through pilot valve member 74, and radially outward through radial outlet orifices 84 into pilot valve chamber 62. When the solenoid is de-energized, axial opening 78 to bore 75 in pilot valve member 74 is closed because of pilot valve member 74 abutting the shank of screw 64. Radial outlet orifices 90 along the length of pilot member 74 are out of alignment with radial bore 66 in main valve member 56, and hence are also closed. The fluid in chamber 62 is therefore at inlet pressure and acts to bias main valve member 56 downwardly against valve seat 50. When the solenoid is initially energized the armature 20 is caused to move upwardly against spring 94, which pulls pilot valve member 74 upward. As pilot valve member 74 moves upwardly, it moves away from screw 64, thus providing greater fluid flow through axial inlet opening orifice 78 into central bore 75. At the same time, radial outlet orifices 90 along the length of pilot valve member 74 become aligned with radial bore 66 in main valve member 56, such that a second flow path is provided through longitudinal bore 68 to housing outlet 48. When orifices 90 are opened, the pressure within pilot valve chamber 62 and central bore 75 is reduced. As main valve member 56 moves away from valve seat 50, fluid flows through a third flow path from housing inlet 42 directly to housing outlet 48 through the radial passages 70 in the main valve member 56. Spring 95 provides that main valve member 56 moves smoothly and evenly in proportion to the movement of pilot valve member 74, and hence in proportion to the input signal amplitude or current on the solenoid. As the current or voltage through the solenoid is increased, the main valve member 56 moves further upwardly and increases the flow to housing outlet 48. This continues until full voltage or current is reached and the housing outlet pressure approaches the housing inlet pressure and full flow is seen at housing outlet 48.

Using the method of this invention, an appropriate pulse width or frequency modulation may be applied to the solenoid coils of the '026 patent and all similar valves, such that the armature 20 is moved to open the pilot valve member, but not to such extent that the pressure within the pilot valve chamber 62 is reduced such that the main valve member 56 is caused to open. By applying such appropriate pulse width or frequency modulation, the pilot valve member 74 will oscillate or bounce on the screw 64, thereby rapidly cycling on and off, and controlling flow at a lower level, and over a range, heretofore not possible.

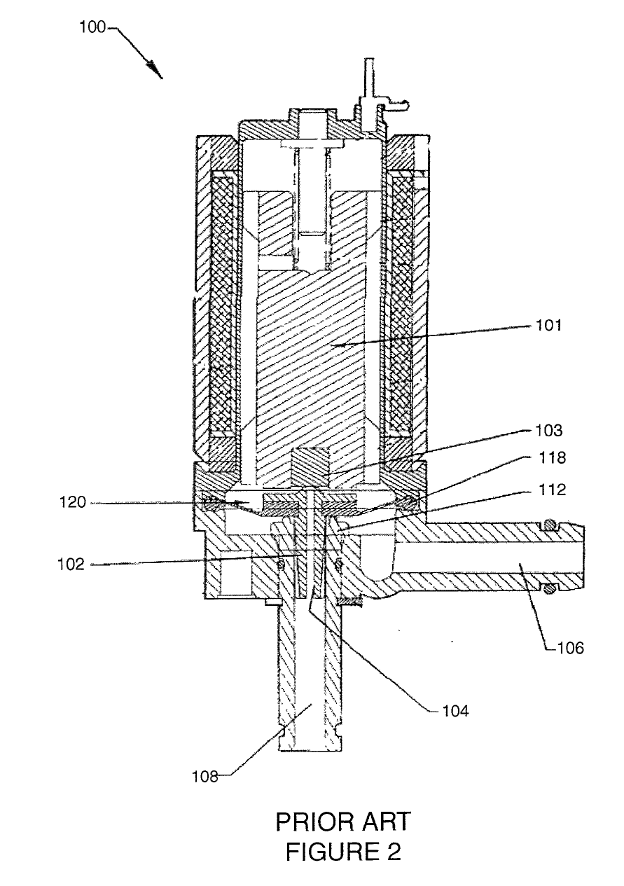

Yet another type of pilot-operated proportional control valve with which this method may be used is disclosed in U.S. Pat. No. 5,716,038, entitle Proportional Flow Control Valve, to M. F. Scarffe (the '038 patent). In this valve a diaphragm is provided. In FIG. 2, the valve 100 of the '038 patent is shown, and is as disclosed therein. As the armature 101 begins to lift, the valve pad 103 connected thereto is lifted from the end of the pilot tube 104 and liquid in the pilot chamber 120 flows through the tube 104 in the main valve member 102 and to the outlet port 108. This flow reduces the pressure in the pilot chamber 120 as compared to the pressure on the other side of the diaphragm 118, and hence the diaphragm 118 begins to lift away from the main valve seat 112 and in doing so lifts the main valve member 102. Flow of liquid from the inlet port 106 to the outlet port 108 through the main valve seat 112 therefore commences. However, the pilot chamber 120 remains in communication with the liquid inlet 106 via the small hole in the diaphragm 118.

Using the method of this invention, an appropriate pulse width or frequency modulation may be applied to the solenoid coils of the '038 patent and all similar valves, such that the armature 101 is moved to open the valve pad member 103, which functions as a pilot valve member, from the end of the pilot tube 104, but not to such as extend that the pressure within the pilot chamber 120 is reduced such that the main valve member 102 is caused to open. By applying such appropriate pulse width or frequency modulation, the valve pad member 103 will oscillate or bounce on its seat 104, thereby rapidly cycling on and off, and controlling flow at a lower level, and over a range, heretofore not possible.

The pulse width or frequency modulation on the solenoid to initially open the pilot valve member, and then the further pulse width or frequency modulation range over which the pilot valve member can be operated without also opening the main valve member, can vary depending upon the spring constant on springs associated with the pilot valve member and springs associated with the main valve member, or the equivalents thereof, the size of the armature, if provided, the length and number of coils on the solenoid, and other factors as should be known to those skilled in the art. Such modifications and variations can be made to a valve, in order to optimize the application of the method of this invention to the valve.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method for controlling a proportional flow valve in a low flow range, the proportional flow valve having
(a) a valve body including an inlet port, an outlet port, and a main valve seat mounted in said body and having an inlet side exposed to said inlet port and an outlet side exposed to said outlet port;
(b) a main valve member having a pilot opening extending therethrough and a pilot seat surrounding said pilot opening;
(c) a pilot valve member movably mounted within said valve body out of and into engagement with the pilot seat to respectively open and close the pilot valve member; and
(d) a solenoid actuator having an armature on which said pilot valve member is mounted for movement therewith, and a coil for producing flux as a function of an electrical current flowing therein, said armature being movable in response to said flux, wherein the main valve member is movably mounted within said valve body out of and into engagement with the main valve seat to respectively open and close the main valve member as a function of the movement of the pilot valve member, the method comprising the steps of:
(1) providing a pulse width modulated voltage signal to said coil, said signal having a selectable maximum voltage and a selectably variable duty cycle, said signal inducing a current in said coil, the current having an average value over time;
(2) varying said duty cycle, thereby varying the average value of the current, thereby causing the pilot valve member to open and close at a desired time-opened to time-closed ratio; and
(3) maintaining the time-opened to time-closed ratio below a value at which the main valve member opens.

2. The method of claim 1, wherein the current in said coil has a frequency f, further comprising the step of maintaining f at a fixed value.

3. The method of claim 1, wherein the current in said coil has a frequency f, further comprising the step of varying f.

4. The method of claim 1, wherein the pulse width modulated voltage signal to said coil is controlled by an electronic control unit.

5. A method for controlling a proportional flow valve in a low flow range, the proportional flow valve having
(a) a valve body including an inlet port, an outlet port, and a main valve seat mounted in said body and having an inlet side exposed to said inlet port and an outlet side exposed to said outlet port;
(b) a main valve member having a pilot opening extending therethrough and a pilot seat surrounding said pilot opening;
(c) a pilot valve member movably mounted within said valve body out of and into engagement with the pilot seat to respectively open and close the pilot valve member; and
(d) a solenoid actuator having an armature on which said pilot valve member is mounted for movement therewith, and a coil for producing flux as a function of an electrical current flowing therein, said armature being movable in response to said flux, wherein the main valve member is movably mounted within said valve body out of and into engagement with the main valve seat to respectively open and close the main valve member as a function of the movement of the pilot valve member, the method comprising the steps of:
(1) providing a pulse width modulated voltage signal to said coil, said signal having a selectable maximum voltage and a selectably variable frequency, said signal inducing a current in said coil, the current having an average value over time;
(2) varying said frequency, thereby varying the average value of the current, thereby causing the pilot valve member to open and close at a desired time-opened to time-closed ratio; and
(3) maintaining the time-opened to time-closed ratio below a value at which the main valve member opens.

6. The method of claim 5, wherein the current in said coil has a duty cycle, further comprising the step of maintaining the duty cycle at a fixed value.

7. The method of claim 6, wherein the current in said coil has a duty cycle, further comprising the step of varying the duty cycle.

8. The method of claim 5, wherein the pulse width modulated voltage signal to said coil is controlled by an electronic control unit.
